(19) United States
(12) Patent Application Publication
(10) Pub. No.: US 2009/0225129 A1
(43) Pub. Date: Sep. 10, 2009

(54) LIQUID EJECTING APPARATUS AND FLUSHING METHOD

(75) Inventor: Eiichi FUKUSHI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/400,579

(22) Filed: Mar. 9, 2009

(30) Foreign Application Priority Data
Mar. 10, 2008 (JP) 2008-059095

(51) Int. Cl. B41J 2/165

(52) U.S. Cl. 347/35

(57) ABSTRACT

A liquid ejecting apparatus that ejects liquid onto a liquid-ejected object includes: an object transport unit; a head unit having a nozzle row; a drying unit that dries the liquid of the liquid-ejected object; a flushing sheet that receives the liquid ejected from the liquid ejecting nozzles; and a flushing control unit that controls a flashing frequency of the liquid ejecting nozzles of the head unit on the basis of positions of the liquid ejecting nozzles, the frequency is related to a positional relationship between positions of the liquid ejecting nozzles and the drying unit.

### BACKGROUND

1. Technical Field

The present invention relates to a liquid ejecting apparatus that ejects liquid onto a liquid-ejected object and a flushing method and in particular, to a technique of forcibly ejecting (flushing) liquid in a nozzle regardless of ejection onto a liquid-ejected object.

2. Related Art

An ink jet printer is known as a liquid ejecting apparatus that ejects liquid onto a liquid-ejected object. In the ink jet printer, printing is performed by ejecting ink onto paper, which is a liquid-ejected object, through a nozzle provided in a head.

In such an ink jet printer, the viscosity of ink increases or the ink is solidified because a solvent of the ink evaporates from the nozzle of the head. As a result, the nozzle may be clogged to cause poor printing.

For this reason, so-called flushing for forcibly ejecting ink in a nozzle regardless of ejection onto the paper and the like is performed. In the flushing, there is a possibility that ink will be uselessly consumed.

Accordingly, a technique of preventing unnecessary consumption of ink is known (for example, refer to JP-A-2006-168150).

In recent years, in order to quickly dry ink ejected onto the paper, it is considered to provide a heater for drying the ink in an ink jet printer. In such an ink jet printer, it may also be considered that a nozzle is easily clogged since a solvent of the ink of a head easily evaporates by the heater. Accordingly, in this case, flushing becomes an important issue.

Moreover, in such an ink jet printer, it is strongly requested to suppress useless consumption of ink in flushing.

### SUMMARY

An advantage of some aspects of the invention is that it provides a technique capable of suppressing useless consumption of ink in flushing while maintaining nozzles of a liquid ejecting apparatus in a suitable state. According to an aspect of the invention, a liquid ejecting apparatus that ejects liquid onto a liquid-ejected object, includes an object transport unit that transports the liquid-ejected object in a predetermined first direction; a head unit having a nozzle row in which a plurality of liquid ejecting nozzles that eject the liquid are arrayed in a second direction approximately perpendicular to the first direction; a drying unit that dries the liquid of the liquid-ejected object onto which the liquid is ejected; a flushing sheet that receives the liquid ejected from the liquid ejecting nozzles at the time of flushing of the head unit; a flushing sheet transport unit that transports the flushing sheet to a position facing the liquid ejecting nozzles of the head unit; a determination unit that determines whether to eject the liquid onto the flushing sheet, which is transported to the position facing the liquid ejecting nozzles, according to the positional relationship between positions of the liquid ejecting nozzles of the head unit and the drying unit for the plurality of liquid ejecting nozzles; and a flushing control unit that controls a flashing frequency of the liquid ejecting nozzles of the head unit on the basis of positions of the liquid ejecting nozzles, the frequency is related to a positional relationship between positions of the liquid ejecting nozzles and the drying unit.

According to another aspect of the invention, a liquid ejecting apparatus that ejects liquid onto a liquid-ejected object includes: an object transport unit that transports the liquid-ejected object in a predetermined first direction; a head unit having a nozzle row in which a plurality of liquid ejecting nozzles that eject the liquid are arrayed in a second direction approximately perpendicular to the first direction; a drying unit that dries the liquid of the liquid-ejected object onto which the liquid is ejected; a flushing sheet that receives the liquid ejected from the liquid ejecting nozzles at the time of flushing of the head unit; a flushing sheet transport unit that transports the flushing sheet to a position facing the liquid ejecting nozzles of the head unit; a flushing control unit that makes the liquid ejected from the liquid ejecting nozzles on the basis of a result of the determination when the flushing sheet is transported to the position facing the liquid ejecting nozzles.

According to the liquid ejecting apparatus, ejection of the liquid through the liquid ejecting nozzles can be appropriately controlled according to the positional relationship between the positions of the liquid ejecting nozzles of the head unit and the drying unit. Therefore, the frequency of flushing can be set differently, for example, according to whether the liquid ejecting nozzle is one at the position where the influence of heat from the drying unit is large or one at the position where the influence of heat from the drying unit is small.

In the liquid ejecting apparatus, the head unit may have the plurality of nozzle rows arrayed at positions shifted from each other in the first direction, the flushing sheet transport unit may transport the flushing sheet in the first direction, and the flushing control unit may make an amount of the liquid that lands on the same row fall within a predetermined amount by controlling liquid ejection timing of the liquid ejecting nozzles of the different nozzle rows, when making the liquid land on the same row of the flushing sheet through the plurality of liquid ejecting nozzles. According to the liquid ejecting apparatus, the liquid which is ejected through the liquid ejecting nozzles of different nozzle rows and which lands on the same row of the flushing sheet is made to fall within the predetermined amount. Therefore, when ejecting ink, it can be appropriately prevented that liquid from other liquid ejecting nozzles strikes the collected liquid to be scattered around the area.

In the liquid ejecting apparatus, the head unit may include a plurality of heads having the nozzle row, the heads may be disposed at upstream and downstream sides of the first direction with respect to the drying unit, and the determination unit may determine whether to eject the liquid such that the frequency, in which the liquid is ejected onto the flushing sheet through the liquid ejecting nozzles of the head disposed at the downstream side of the first direction with respect to the drying unit, is larger than the frequency in which the liquid is ejected onto the flushing sheet through the liquid ejecting nozzles of the head disposed at the upstream side of the first direction. According to the liquid ejecting apparatus, the liquid can be ejected in a higher frequency from the liquid ejecting nozzles of the head located at the downstream side where the influence of heat of the drying unit is large. As a result, it can be appropriately prevented that the liquid ejecting nozzles are clogged.

According to another aspect of the invention, a flushing method of a liquid ejecting apparatus that ejects liquid onto an object and dries the liquid ejected onto the object, includes, transporting a flushing sheet to a position facing liquid ejecting nozzles of a head unit; ejecting liquid on the flushing sheet when the flushing sheet is transported to the position facing liquid ejecting nozzles; controlling a flashing frequency of the liquid ejecting nozzles of the head unit on the basis of positions of the liquid ejecting nozzles, the frequency is related to a positional relationship between positions of the liquid ejecting nozzles and the drying unit.

According to another aspect of the invention, a flushing method of a liquid ejecting apparatus that ejects liquid onto a liquid-ejected object includes: determining whether to eject the liquid onto a flushing sheet, which is transported to a position facing liquid ejecting nozzles, according to the positional relationship between positions of the liquid ejecting nozzles of a head unit and a drying unit for the plurality of liquid ejecting nozzles by means of a determination unit of the liquid ejecting apparatus; and making a flushing control for ejecting the liquid from the liquid ejecting nozzles on the basis of a result of the determination when the flushing sheet is transported to the position facing the liquid ejecting nozzles by means of a flushing control unit of the liquid ejecting apparatus, wherein the liquid ejecting apparatus includes: an object transport unit that transports the liquid-ejected object in a predetermined first direction; a head unit having a nozzle row in which a plurality of liquid ejecting nozzles that eject the liquid are arrayed in a second direction approximately perpendicular to the first direction; a drying unit that dries the liquid of the liquid-ejected object onto which the liquid is ejected; a flushing sheet that receives the liquid ejected from the liquid ejecting nozzles at the time of flushing of the head unit; and a flushing sheet transport unit that transports the flushing sheet to a position facing the liquid ejecting nozzles of the head unit.

According to the flushing method, ejection of the liquid through the liquid ejecting nozzles can be appropriately controlled according to the positional relationship between the positions of the liquid ejecting nozzles of the head unit and the drying unit. Therefore, the frequency of flushing can be set differently, for example, according to whether the liquid ejecting nozzle is one at the position where the influence of the drying unit is large or one at the position where the influence of the drying unit is small.

### BRIEF DESCRIPTION OF THE DRAWINGS

The invention will be described with reference to the accompanying drawings, wherein like numbers reference like elements.

FIG. 1 is a view illustrating the configuration of a printer according to an embodiment of the invention.

FIG. 2 is a view illustrating the arrangement of heads of the printer according to the embodiment of the invention.

FIG. 3 is a view illustrating the functional configuration of the printer according to the embodiment of the invention.

FIGS. 4A and 4B are views illustrating the relationship between types of ranges and the frequency of flushing in the range in the embodiment of the invention.

FIG. 5 is a flow chart illustrating flushing processing according to another embodiment of the invention.

FIGS. 6A and 6B are views illustrating the relationship between types of ranges and the frequency of flushing in the range in a modification of the invention.

FIG. 7 is a flow chart illustrating flushing processing in the modification of the invention.

### DESCRIPTION OF EXEMPLARY EMBODIMENTS

Embodiments of the invention will now be described with reference to the accompanying drawings. In addition, the embodiments described below are not intended to limit the invention defined in the appended claims, and all components and combination thereof described in the embodiments are not necessarily essential to the invention.

First, a printer as an example of a liquid ejecting apparatus according to an embodiment of the invention will be described.

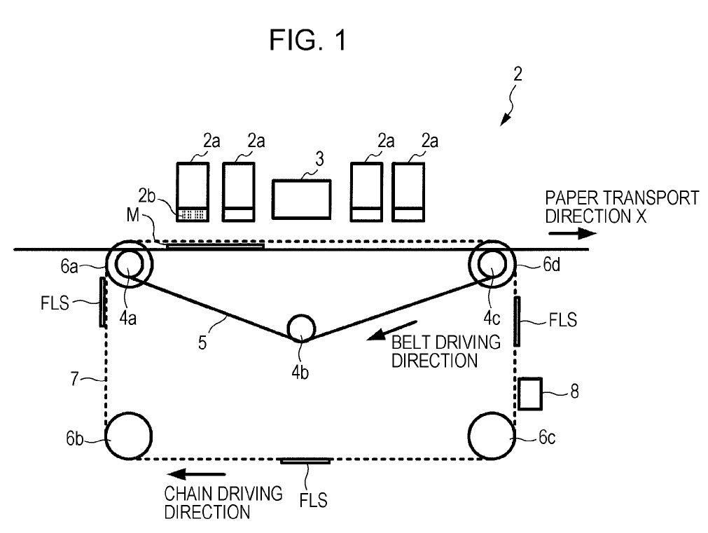

FIG. 1 is a view illustrating the configuration of a printer according to an embodiment of the invention, and

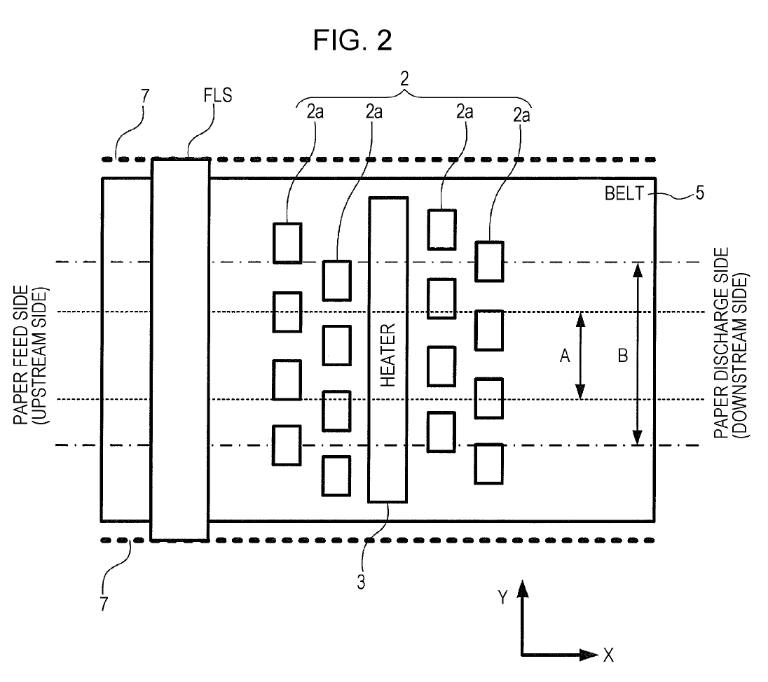

FIG. 2 is a view illustrating the arrangement of heads of the printer according to the embodiment of the invention.

In a printer 1, a head unit 2 having a plurality of heads 2a for ejecting ink (liquid) onto paper (liquid-ejected object) M. A plurality of nozzles (liquid ejecting nozzles) 2b that eject ink are provided toward a transport side of the paper M in the head 2a. In the present embodiment, in the head 2a, for example, a nozzle row in which the plurality of nozzles 2b (for example, 180 nozzles 2b) are arrayed is formed in a drawing depth direction Y (second direction) perpendicular to a paper transport direction X (first direction) and a plurality of nozzle rows (for example, eight rows) arrayed in the paper transport direction X are formed. For example, in the case of a printer that performs printing using ink of four colors, two nozzle rows are assigned to each color of yellow, magenta, cyan, and black and the nozzle rows corresponding to the same color are disposed such that the positions of nozzles in the direction Y are shifted from each other by a predetermined amount (for example, half of the nozzle pitch in a nozzle row).

In the head unit 2, as shown in FIG. 2, the heads 2a are arrayed in plural rows (for example, four rows) along the paper transport direction X in which the paper M is transported and the plurality of heads 2a (for example, four heads 2a) are arrayed in the direction Y perpendicular to the paper transport direction X.

The plurality of heads 2a in a first row (shown in order from a paper feed side on a left side of the drawing; the same hereinbelow) are arrayed in the direction Y at predetermined distances therebetween. The plurality of heads 2a in a second row are arrayed such that each of the heads 2a in the second row overlaps, at positions in the direction Y, a range of each head 2a in the first row where at least some nozzles exist and a space between the heads 2a in the first row in the direction Y is filled. By the heads 2a in the first and second rows, ink can be ejected over the entire predetermined range in the direction Y with predetermined resolution (for example, 360 dpi).

Furthermore, the plurality of heads 2a in a third row are arrayed such that the positions of nozzles are shifted by a predetermined amount (for example, ¼ of the nozzle pitch in a nozzle row) from the positions of nozzles of the plurality of heads 2a in the first row in the direction Y. The plurality of heads 2a in a fourth row are arrayed such that each head 2a in the fourth row overlaps, in the direction Y, a range of each head 2a in the third row where at least some nozzles exist and a space between the heads 2a in the third row in the direction Y is filled. Furthermore, the plurality of heads 2a in the fourth row are arrayed such that the positions of nozzles are shifted by a predetermined amount (for example, ¼ of the nozzle pitch in a nozzle row) from the positions of nozzles of the plurality of heads 2a in the first row in the direction Y. By the heads 2a in the third and fourth rows, ink can be ejected over the entire predetermined range in the direction Y with predetermined resolution (for example, 360 dpi).

In addition, the positions of nozzles of the heads 2a in the first and second rows in the direction Y are shifted by a predetermined amount from each other and the positions of nozzles of the heads 2a in the third and fourth rows in the direction Y are shifted by a predetermined amount from each other. Accordingly, the resolution can be doubled (for example, 720 dpi) over the entire predetermined range in the direction Y.

Between the heads 2a in the second and third rows, a heater 3 as an example of a drying unit for drying ink ejected onto the paper M is provided.

Moreover, in the printer 1, the paper M transported from a paper feed tray (not shown) is transported in the paper transport direction X by a belt 5 and is then transported to a paper discharge tray (not shown). The belt 5 is stretched over rollers 4a, 4b, and 4c and is driven by a motor (not shown).

Furthermore, in the printer 1, a plurality of sprockets 6a, 6b, 6c, and 6d are provided and a chain 7 is stretched over the sprockets 6a, 6b, 6c, and 6d. A flushing sheet FLS that receives the ink ejected from the nozzles 2b of the head 2a at the time of flushing is mounted on the chain 7. The flushing sheet FLS may be a member that does not absorb ink or may be a member that absorbs ink. In the present embodiment, the flushing sheet FLS is mounted at three places of the chain 7. As shown in FIG. 2, the chain 7 is provided to be positioned at each of both sides of the belt 5, such that the flushing sheet FLS is mounted on both the chains 7.

A motor (not shown) is connected to the sprockets 6a, 6b, 6c, and 6d. The sprockets 6a, 6b, 6c, and 6d are rotated in the clockwise direction of the drawing by the motor, which drives the chain 7 and the flushing sheet FLS in the clockwise direction of the drawing.

In the printer 1, a cleaning unit 8 is provided to face a region through which the flushing sheet FLS mounted on the chain 7 passes. The cleaning unit 8 removes the ink ejected onto the flushing sheet FLS. As a method of removing ink, the flushing sheet FLS may be wiped, for example.

The printer 1 is configured to be able to perform printing on the paper M with a plurality of sizes. For example, as shown in FIG. 2, a range A is transported to be printed in the case of the paper M with a small paper width and a range B is transported to be printed in the case of the paper M with a large paper width.

Next, the functional constitution of the printer 1 will be described.

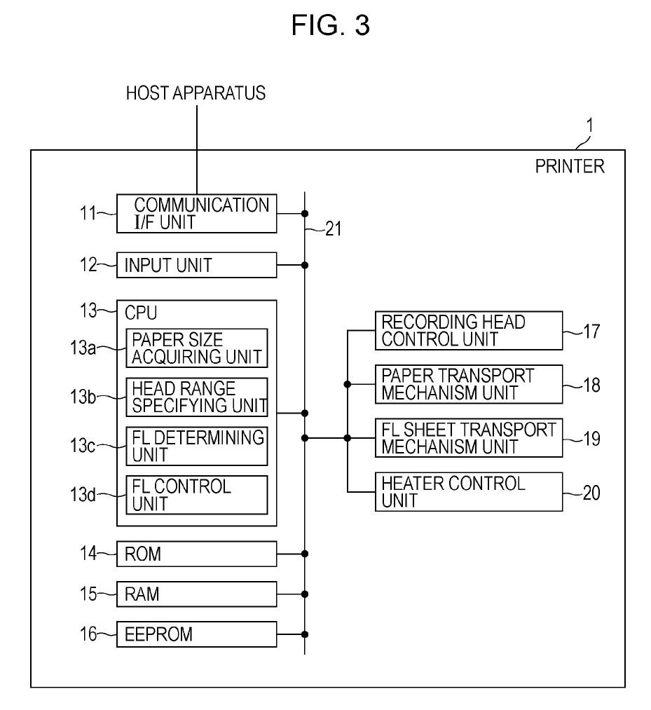

FIG. 3 is a view illustrating the functional configuration of the printer according to the embodiment of the invention.

In the printer 1, a communication interface unit (communication I/F portion) 11, an input unit 12, a CPU (central processing unit) 13, a ROM (read only memory) 14, a RAM (random access memory) 15, an EEPROM (electrically erasable programmable read-only memory) 16, a recording head control unit 17, a paper transport mechanism unit 18 as an example of an object transport means, an FL sheet transport mechanism unit 19 as an example of a flushing sheet transport means, and a heater control unit 20 are connected to one another through a bus 21.

The communication I/F unit 11 exchanges print data and the like with a host apparatus (not shown). The input unit 12 has a key, for example, and receives various kinds of instruction input from a user of the printer 1 and notifies the input to the CPU 13.

The ROM 14 stores a program, such as a boot program. The RAM 15 is used as a region, in which a program or data is stored, or a working area, in which data used for processing of the CPU 13 is stored. The EEPROM 16 is a rewritable nonvolatile memory and stores various kinds of information that needs to be stored even if the power is not supplied to the printer 1. In the present embodiment, for example, for every size of the paper M, information on a range in the printer 1 and the frequency of flushing in the range is stored in a state where the range and the frequency of flushing match each other.

The recording head control unit 17 controls ejection of ink using the head 2a. The paper transport mechanism unit 18 has rollers 4a, 4b, and 4c, the belt 5, a motor, and the like and serves to transport the paper M. The FL sheet transport mechanism unit 19 has the sprockets 6a, 6b, 6c, and 6d, a motor, the flushing sheet FLS, and the like and serves to transport the flushing sheet FLS. In the present embodiment, the FL sheet transport mechanism unit 19 is transported such that the flushing sheet FLS passes below the head 2a after a predetermined number of sheets of paper M (for example, a sheet of paper or two or more sheets of paper) passes below the head 2a. The heater control unit 20 performs a heating control of the heater 3.

The CPU 13 controls operations of the units 11, 12, and 14 to 20. In addition, the CPU 13 realizes a paper size acquiring unit 13a, a head range specifying unit 13b, an FL determining unit 13c as an example of a determination means, and an FL control unit 13d as an example of a flushing control unit by reading a program stored in the ROM 14 into the RAM 15 and executes the program.

The paper size acquiring unit 13a acquires the size of the paper M being printed. As a method of acquiring the size of the paper M, the size may be acquired by detection using a sensor or may be acquired by using information on paper setting of a user. The head range specifying unit 13b specifies in which range each head 2a is located in the positional relationship with the heater 3 on the basis of the size acquired by the paper size acquiring unit 13a.

Here, in the present embodiment, an influence of heat from the heater 3 is taken into consideration as follows. That is, the heads 2a located at the downstream side of the heater 3 are influenced by heat more strongly as the heads 2a are closer to the heater 3. In addition, the head 2a located near the heater 3 is influenced by heat more strongly than the head 2a far from the heater 3. Moreover, the belt 5 has a portion on which the paper M is placed and a portion on which the paper M is not placed. Since the belt 5 in the present embodiment is black, heat is easily absorbed and radiant heat is easily generated. Accordingly, the head 2a located at the portion (outside a paper passing range) on which the paper M is not placed is influenced by heat more strongly than the head 2a located at the portion (paper passing range) on which the paper M is placed. In consideration of such an influence of heat of the heater 3, the range in the printer 1 and the flushing frequency in the range are determined as follows.

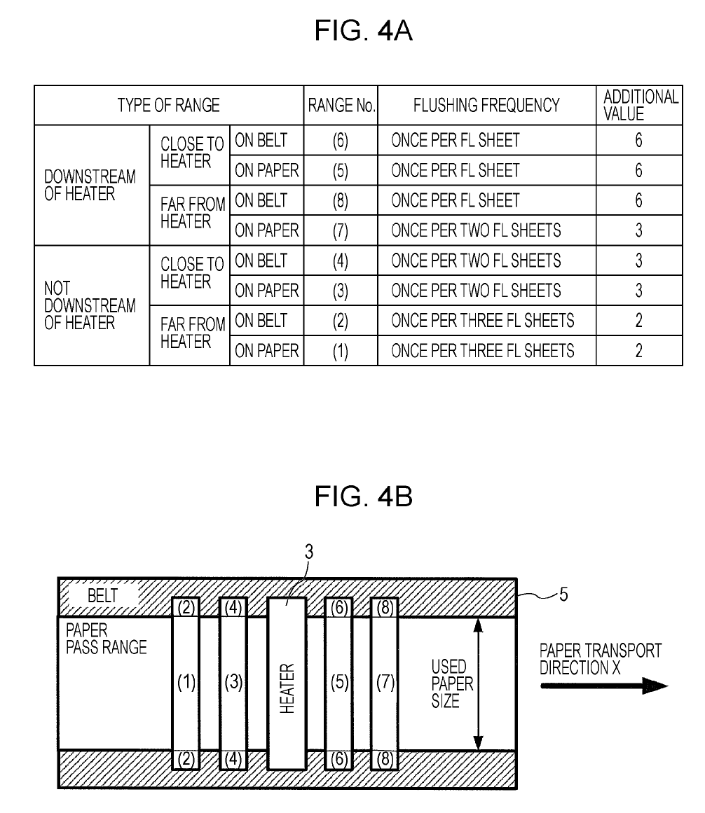

FIGS. 4A and 4B are views illustrating the relationship between types of ranges and the frequency of flushing in the range in the embodiment of the invention. FIG. 4A shows a range type, a flushing frequency in the range, and an additional value in processing for realizing the flushing frequency, and FIG. 4B shows the specific position of the type of each range in the printer 1.

Types of ranges include: a range (6) which is located at a downstream side of the heater 3, is close to the heater 3, and is on the belt 5; a range (5) which is located at the downstream side of the heater 3, is close to the heater 3, and is on the paper M (paper passing range); a range (8) which is located at the downstream side of the heater 3, is far from the heater 3, and is on the belt 5; a range (7) which is located at the downstream side of the heater 3, is far from the heater 3, and is on the paper passing range; a range (4) which is not located at the downstream side of the heater 3, is close to the heater 3, and is on the belt 5; a range (3) which is not located at the downstream side of the heater 3, is close to the heater 3, and is on the paper passing range; a range (2) which is not located at the downstream side of the heater 3, is far from the heater 3, and is on the belt 5; and a range (1) which is not located at the downstream side of the heater 3, is far from the heater 3, and is on the paper passing range. In the present embodiment, such additional value and frequency of flushing in each range where the head 2a exists are determined beforehand, and the relationship is stored in the EEPROM 16.

For example, for the head 2a at least a part of which belongs in the range (6) which is located at the downstream side of the heater 3, is close to the heater 3, and is on the belt 5, flushing is performed once when the flushing sheet FLS passes once and the additional value used in processing for realizing the frequency is set to ‘6’. In addition, for the head 2a at least a part of which belongs in the range (5) which is located at the downstream side of the heater 3, is close to the heater 3, and is on the paper passing range, flushing is performed once when the flushing sheet FLS passes once and the additional value for realizing the frequency is set to ‘6’.

Here, since the printer 1 can process the paper M with a plurality of sizes, the actual position corresponding to a range that is either on the belt 5 or on the paper passing range changes for every size of the paper M. Therefore, in the present embodiment, actual position coordinates of each range are stored in the EEPROM 16 so as to correspond to each size of the paper M, such that the head range specifying unit 13b determines in which range each head 2a belongs on the basis of the coordinates of each head 2a and the actual position coordinates of each range stored in the EEPROM 16. Thus, the range in which the head 2a belongs can be appropriately specified even if the size of the paper M changes.

The FL determining unit 13c determines whether to flush the corresponding head 2a on the basis of the range specified by the head range specifying unit 13b. In the present embodiment, the FL determining unit 13c determines whether to flush each head 2a such that each range corresponds to the frequency shown in FIG. 4A.

The FL control unit 13d controls the recording head control unit 17 such that ink is ejected onto the flushing sheet FLS through the nozzle 2b of the head 2a, which has been determined that flushing is to be performed by the FL determining unit 13c.

Next, flushing processing according to another embodiment of the invention will be described.

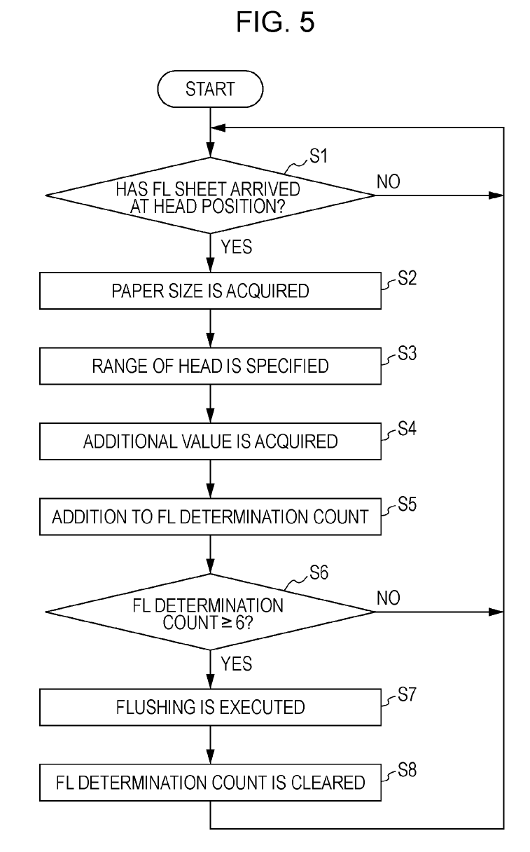

FIG. 5 is a flow chart illustrating the flushing processing according to the embodiment of the invention. The flushing processing is executed for each head 2a.

First, the FL control unit 13d determines whether or not the flushing sheet FLS has reached a predetermined position (for example, an upstream end of the head 2a) of the head 2a to be processed (step S1). When the flushing sheet FLS has not reached the predetermined position, subsequent processing is waited until the flushing sheet FLS reaches the predetermined position. On the other hand, when the flushing sheet FLS has reached the predetermined position of the head 2a (step S1: YES), the paper size acquiring unit 13a acquires the size of the paper M being printed (step S2). Then, the head range specifying unit 13b specifies in which type of range shown in FIG. 4 the head 2a to be processed belongs on the basis of the size of the paper M acquired by the paper size acquiring unit 13a (step S3).

The FL determining unit 13c acquires an additional value, which corresponds to the range specified by the head range specifying unit 13b, from the EEPROM 16 (step S4) and adds the additional value to an FL determination count (step S5). Subsequently, the FL determining unit 13c determines whether or not the FL determination count is 6 or more (step S6). When the FL determination count is not 6 or more (step S6: NO), the process returns to step S1 since it means that flushing is not performed on the flushing sheet FLS that has arrived. On the other hand, when the FL determination count is 6 or more (step S6: YES), it means that flushing is performed on the flushing sheet FLS that has arrived. Accordingly, in this case, the FL control unit 13d controls the recording head control unit 17 such that ink is ejected onto the flushing sheet FLS by the head 2a to be processed, that is, flushing is executed (step S7). Then, the FL control unit 13d clears the FL determination count (step S8) returning to step S1.

According to the above-described embodiment, the frequency of flushing may be appropriately changed according to which range, in which the head 2a is influenced by heat of the heater 3, the head 2a belongs. In this manner, it is possible to appropriately prevent the nozzle 2b of the head 2a from being clogged and to reduce unnecessary consumption of ink.

Then, a printer in a modification of the invention will be described. Moreover, since the printer in the modification has the same configuration as the printer 1 according to the above-described embodiment, a difference therebetween will be mainly described with reference to FIGS. 1 to 3.

The head range specifying unit 13b in this modification specifies in which range each head 2a is located in the positional relationship with the heater 3 and the like. Moreover, in this modification, types of ranges specified are different from those in the above-described embodiment.

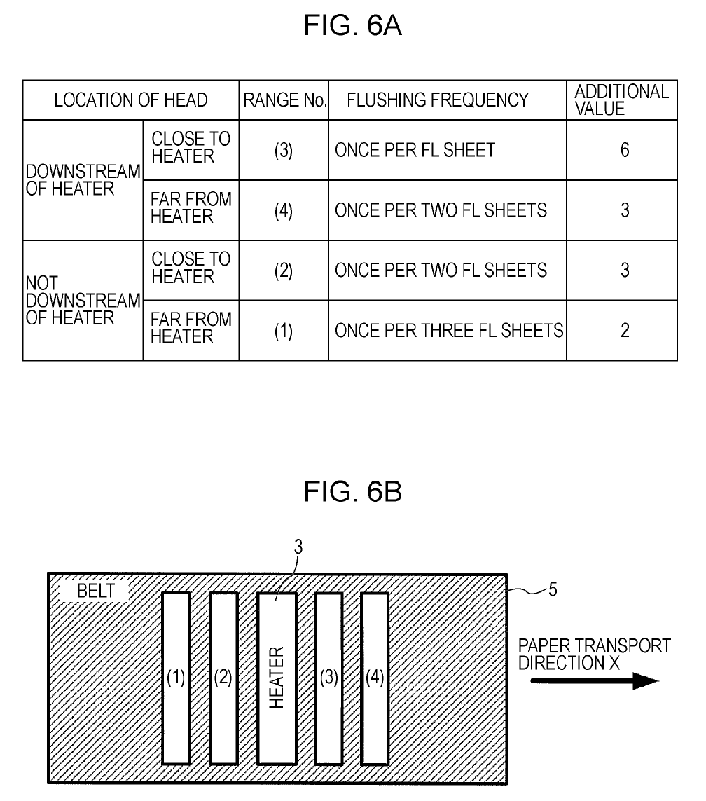

FIGS. 6A and 6B are views illustrating the relationship between types of ranges and the frequency of flushing in the range in the modification of the invention. FIG. 6A shows a range type, a flushing frequency in the range, and an additional value in processing for realizing the flushing frequency, and FIG. 6B shows the specific position of the type of each range in the printer 1.

For the head 2a at least a part of which belongs in the range (3) which is located at the downstream side of the heater 3 and is close to the heater 3, flushing is performed once when the flushing sheet FLS passes once and the additional value for realizing the frequency is set to ‘6’. In addition, for the head 2a at least a part of which belongs in the range (4) which is located at the downstream side of the heater 3 and is far from the heater 3, flushing is performed once when the flushing sheet FLS passes twice and the additional value for realizing the frequency is set to ‘3’. In addition, for the head 2a at least a part of which belongs in the range (2) which is not located at the downstream side of the heater 3 and is close to the heater 3, flushing is performed once when the flushing sheet FLS passes twice and the additional value for realizing the frequency is set to ‘3’. In addition, for the head 2a at least a part of which belongs in the range (1) which is not located at the downstream side of the heater 3 and is far from the heater 3, flushing is performed once when the flushing sheet FLS passes three times and the additional value for realizing the frequency is set to ‘2’. Such additional value and frequency of flushing in each range where the head 2a exists are determined beforehand, and the relationship is stored in the EEPROM 16.

The FL control unit 13d in this modification controls the recording head control unit 17 such that ink is ejected onto the flushing sheet FLS by the head 2a, which has been determined that flushing is to be performed by the FL determining unit 13c. In this case, the FL control unit 13d makes a control such that the positions on the flushing sheet FLS, onto which ink is ejected through the nozzles 2b of different nozzle rows the number of which is equal to or smaller than a predetermined number, are on the same row extending in the direction Y. When the number of nozzle rows for ejection onto the same row exceeds a predetermined number, that is, when the amount of ink that lands on the same row exceeds a predetermined amount, the FL control unit 13d makes a control such that ink is ejected onto the positions deviating from the rows on the flushing sheet FLS. By performing such a control, ink on the flushing sheet FLS can be collected within a predetermined amount and the ink can be easily wiped from the flushing sheet FLS. In addition, the ink collected can be suppressed within the predetermined amount. Accordingly, when ejecting ink, it can be appropriately prevented that ink from the nozzle 2b strikes the collected ink to be scattered around the area.

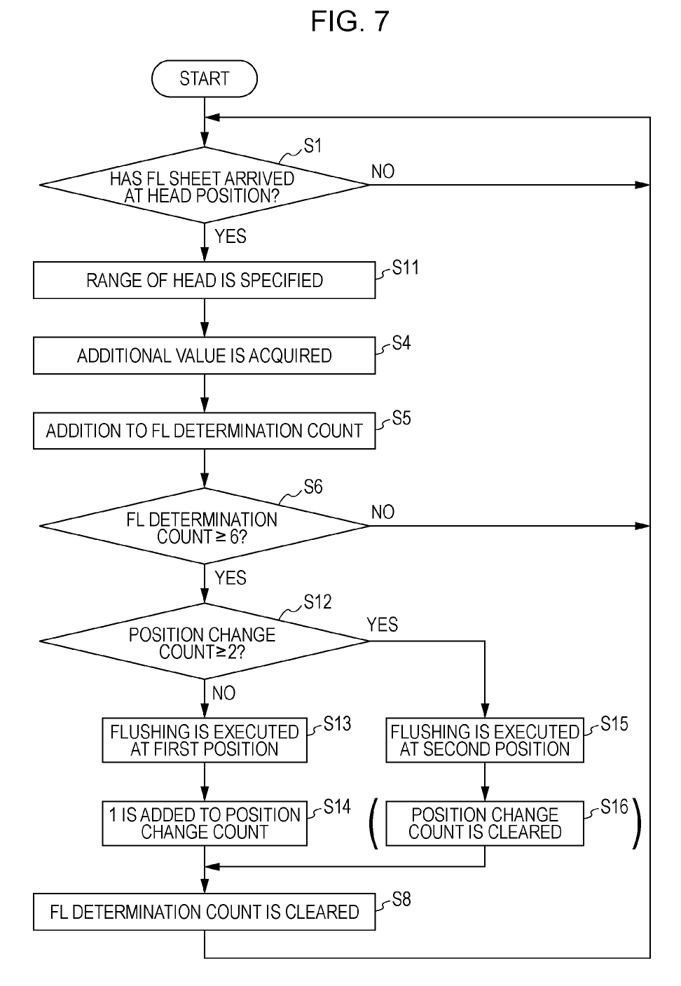

FIG. 7 is a flow chart illustrating the flushing processing in the modification of the invention. In addition, the same portions as in FIG. 5 are denoted by the same reference numerals. In this modification, the plurality of heads 2a located in a row in the direction Y are set to objects to be processed, and the following flushing processing is executed for every row.

In step S11, the head range specifying unit 13b specifies in which type of range shown in FIG. 6A the head 2a of the row to be processed belongs. Then, in step S12, the FL control unit 13d determines whether or not a position change count is 2 or more. As a result, when the position change count is not 2 or more (step S12: NO), it means that ink is not ejected onto the same row of the flushing sheet FLS through the two heads 2a. Accordingly, in this case, the FL control unit 13d controls the recording head control unit 17 such that ink is ejected onto a predetermined first position on the flushing sheet FLS through the corresponding head 2a (step S13) and adds 1 to the position change count (step S14).

On the other hand, when the position change count is 2 or more (step S12: YES), it means that ink is already ejected onto the same row of the flushing sheet FLS through the two heads 2a, that is, up to 16 nozzle rows. Accordingly, in this case, the FL control unit 13d controls the recording head control unit 17 such that ink is ejected onto a second position on the flushing sheet FLS, which is different from the first position, through the corresponding head 2a (step S15). In addition, when an object to be processed is the head 2a of a lowermost row, the position change count is cleared to 0 after step S15 (step S16).

While the invention has been described with reference to the embodiments, the invention is not limited to the above-described embodiments and may also be applied to other various embodiments. For example, although the heater 3 is disposed above the plane on which paper is transported in the embodiment described above, the arrangement of the heater 3 is not limited thereto. For example, it is also possible to dry ink from a bottom surface of the paper M. In addition, although the frequency of flushing is not changed according to whether the range is on the belt or in the paper passing range in the modification, the frequency of flushing may also be changed according to whether the range is on the belt or in the paper passing range.

Furthermore, although the printer was described as an example of a liquid ejecting apparatus in the above embodiment, the invention is not limited thereto and may also be applied to liquid ejecting apparatuses that eject liquid other than ink, for example, liquid-like body including a material having a predetermined characteristic. For example, the invention may also be applied to liquid ejecting apparatuses that eject liquid (liquid-like body) in which a material, such as an electrode material or a color material, which is used in manufacturing a liquid crystal display, an EL (electroluminescence) display, a surface emitting display, and the like, is dispersed or dissolved.

What is claimed is:

1. A liquid ejecting apparatus that ejects liquid onto a liquid-ejected object, comprising:
an object transport unit that transports the liquid-ejected object in a predetermined first direction;
a head unit having a nozzle row in which a plurality of liquid ejecting nozzles that eject the liquid are arrayed in a second direction approximately perpendicular to the first direction;
a drying unit that dries the liquid of the liquid-ejected object onto which the liquid is ejected;
a flushing sheet that receives the liquid ejected from the liquid ejecting nozzles at the time of flushing of the head unit;
a flushing sheet transport unit that transports the flushing sheet to a position facing the liquid ejecting nozzles of the head unit;
a flushing control unit that controls a flashing frequency of the liquid ejecting nozzles of the head unit on the basis of positions of the liquid ejecting nozzles, the frequency is related to a positional relationship between positions of the liquid ejecting nozzles and the drying unit.

2. The liquid ejecting apparatus according to claim 1,
wherein the head unit has the plurality of nozzle rows arrayed at positions shifted from each other in the first direction,
the flushing sheet transport unit transports the flushing sheet in the first direction, and
when making the liquid land on the same row of the flushing sheet through the plurality of liquid ejecting nozzles, the flushing control unit makes an amount of the liquid that lands on the same row fall within a predetermined amount by controlling liquid ejection timing of the liquid ejecting nozzles of the different nozzle rows.

3. The liquid ejecting apparatus according to claim 1,
wherein the head unit includes a plurality of heads having the nozzle row,
the heads are disposed at upstream and downstream sides of the first direction with respect to the drying unit, and
a determination unit determines whether to eject the liquid such that the frequency, in which the liquid is ejected onto the flushing sheet through the liquid ejecting nozzles of the head disposed at the downstream side of the first direction with respect to the drying unit, is larger than the frequency in which the liquid is ejected onto the flushing sheet through the liquid ejecting nozzles of the head disposed at the upstream side of the first direction.

4. A flushing method of a liquid ejecting apparatus that ejects liquid onto an object and dries the liquid ejected onto the object, comprising:
transporting a flushing sheet to a position facing liquid ejecting nozzles of a head unit;
ejecting liquid on the flushing sheet when the flushing sheet is transported to the position facing liquid ejecting nozzles;
controlling a flashing frequency of the liquid ejecting nozzles of the head unit on the basis of positions of the liquid ejecting nozzles, the frequency is related to a positional relationship between positions of the liquid ejecting nozzles and the drying unit.
